(19) United States
(12) Patent Application Publication
(10) Pub. No.: US 2023/0221235 A1
(43) Pub. Date: Jul. 13, 2023

(54) Portable Window Testing Chamber

(71) Applicant: Carlos Villarino Rogers, Charleston, SC (US)

(72) Inventor: Carlos Villarino Rogers, Charleston, SC (US)

(21) Appl. No.: 17/952,204

(22) Filed: Sep. 23, 2022

Related U.S. Application Data
(60) Provisional application No. 63/247,757, filed on Sep. 23, 2021.

(51) Int. Cl. G01N 15/08

(52) U.S. Cl. CPC G01N 15/0806

(57) ABSTRACT

A water penetration testing chamber comprises male extrusions and female extrusions wherein the male extrusions have exterior surfaces that slide into the space defined by the female extrusions' interior surfaces and the female extrusions each have an interior surface against which the male extrusions' exterior surfaces can slide creating a plurality of male/female telescoping extrusion assemblies; and corners to which male/female telescoping extrusion assemblies attach; wherein adjustment of male/female telescoping extrusion assemblies allows altering the length and width of the water penetration testing chamber to fit the exact size of a rough opening of a window or door assembly.

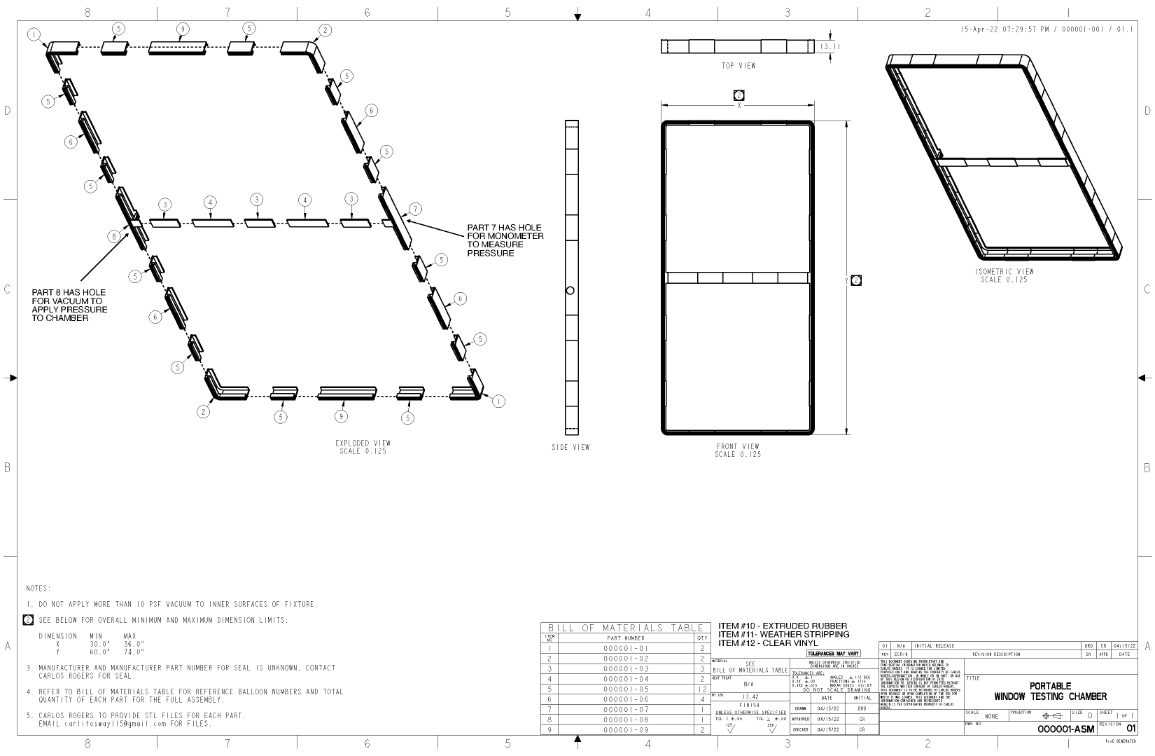

A portable testing chamber according to the present invention can be put in a portable carrying case that can be checked in on an airline, assembled anywhere and be part of a complete kit as shown in FIG. 8 in order to test windows for water penetration per AAMA standards. This chamber can be constructed in a variety of sizes to fit a broad range of window sizes and can be reusable. This has advantages over the traditional method of buying lumber and fasteners and duct tape and using woodworking tools to construct testing chamber.

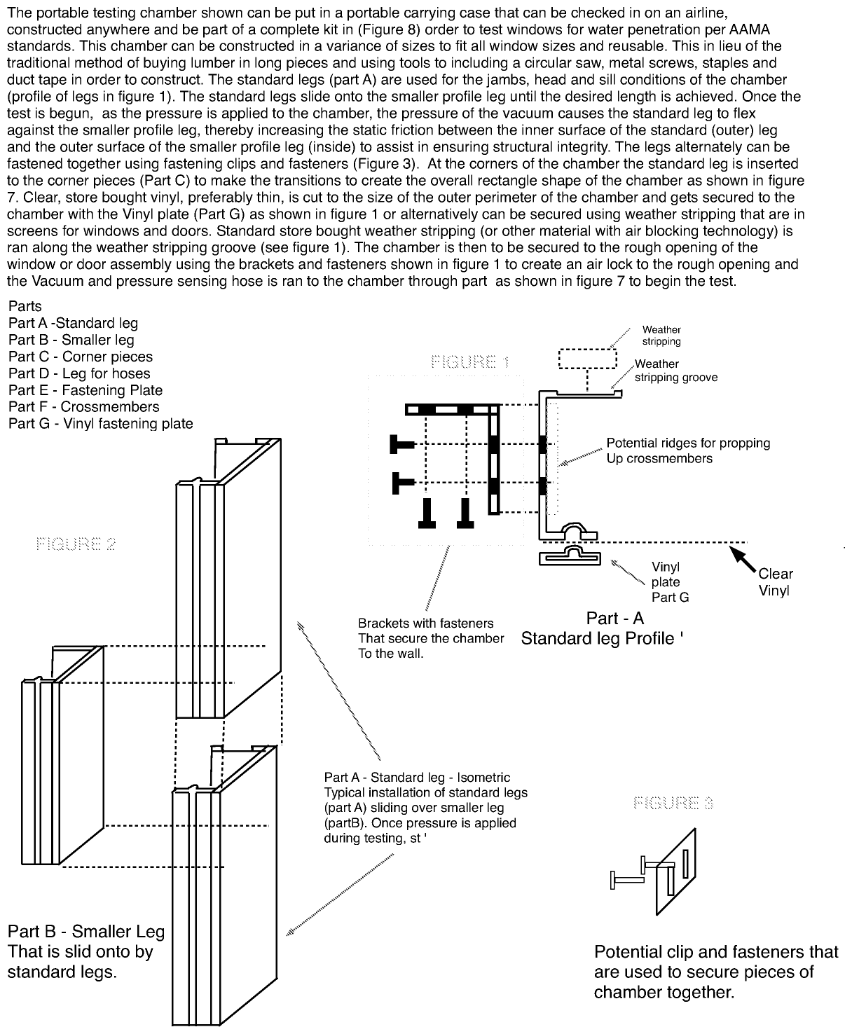

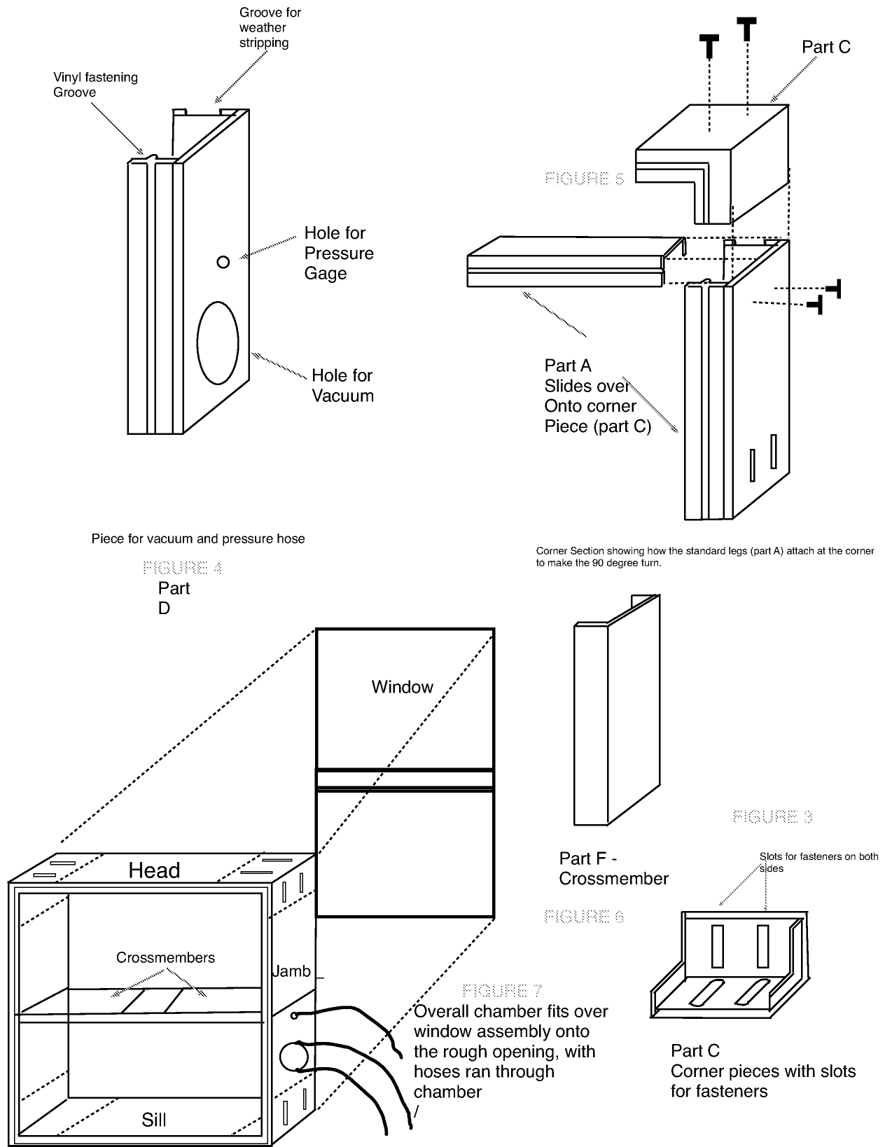

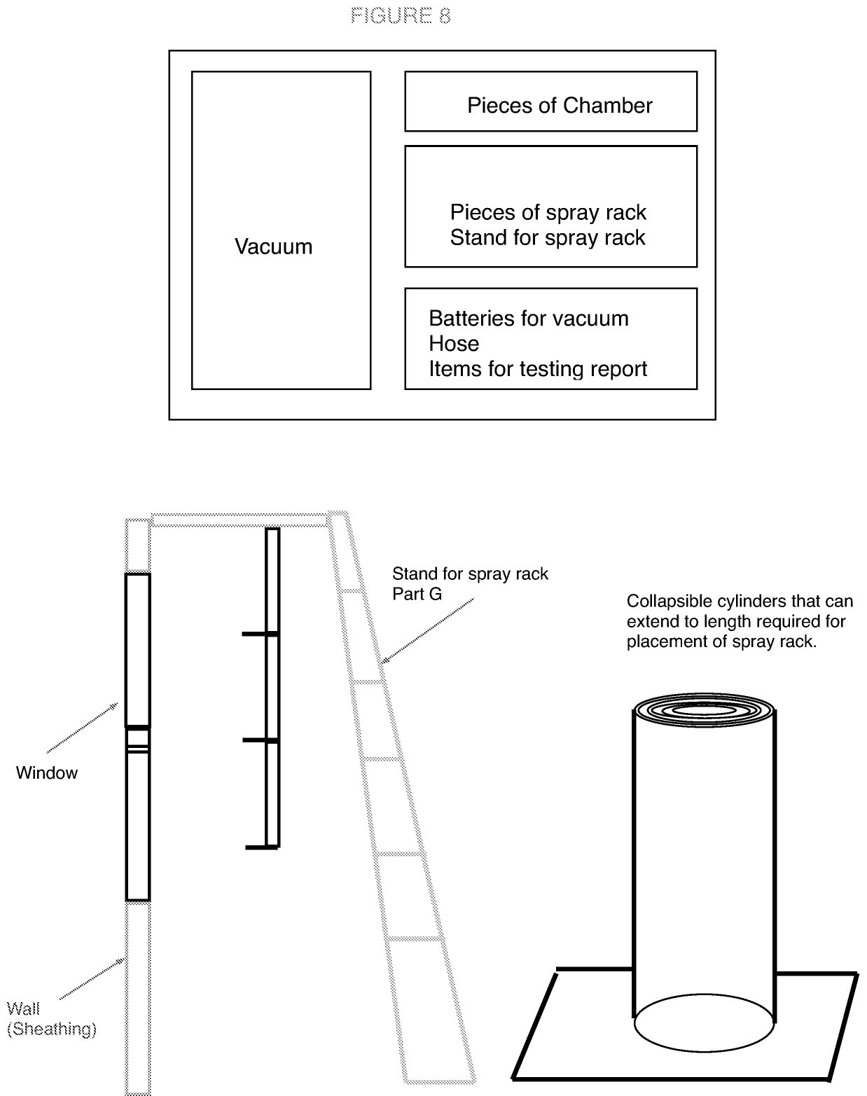

Standard legs (part A) are used for the jambs, head, and sill conditions of the chamber. An example of a standard leg's profile is shown FIG. 1. The standard legs slide onto the smaller profile leg until the desired length is achieved. Once a test begins, as the pressure is applied to the chamber, the pressure of the vacuum causes the standard leg to flex against the smaller profile leg, thereby increasing the static friction between the inner surface of the standard (outer) leg and the outer surface of the smaller pro [symbol] le leg (inner) to assist in ensuring structural integrity. The legs alternately can be fastened together using fastening clips and fasteners (FIG. 3). At the corners of the chamber the standard leg is inserted into the corner pieces (Part C) to make the transitions to create the overall rectangle shape of the chamber as shown in FIG. 7. Clear vinyl, preferably thin, is cut to the size of the outer perimeter of the chamber and is secured to the chamber with the Vinyl plate (Part G) as shown in FIG. 1 or alternatively can be secured using weather stripping as used in screens for windows and doors. Weather stripping (or other comparably flexible material) is emplaced along the weather-stripping groove (see FIG. 1). The chamber is then secured to a window's or door's rough opening using brackets and fasteners as shown in FIG. 1 to create an air lock to the rough opening and a vacuum and pressure sensing hose is connected to the chamber via the “leg for hoses” component as shown in FIG. 7.

A water penetration testing chamber comprises male extrusions and female extrusions wherein the male extrusions have exterior surfaces that slide into the space defined by the female extrusions' interior surfaces and the female extrusions each have an interior surface against which the male extrusions' exterior surfaces can slide creating a plurality of male/female telescoping extrusion assemblies and corners to which male/female telescoping extrusion assemblies attach. Adjustment of male/female telescoping extrusion assemblies allows altering the length and width of the water penetration testing chamber to fit the exact size of a rough opening of a window or door assembly.

The perimeter male and female extrusions can be in the shape of a C-channel, with hollowed out sections on the top and lower C sides. On the top side of the C-channel, a profile of the shape of the extruded rubber, used to lock clear plastic vinyl inside of it, is hallowed out. On the bottom side of the C-channel is a depression of a 1/16 inch, ¾″ wide, is made for soft weather stripping, that is pressed up against the rough opening/wall to create an air tight seal during testing.

### SECTION 1—DESCRIPTION OF GEOMETRIC SHAPES OF PARTS FOR CREATION OF THE ADJUSTABLE CHAMBER AND HOW THEY FIT TOGETHER

The chamber comprises solid (male) plastic extrusions that slide into hollow thin plastic extrusion sleeves (female) with the exact same profile of the male extrusions, creating telescoping pieces, altering the length and width of the chamber to fit the exact size of a rough opening of a window assembly. The perimeter male and female extrusions are in the shape of a C-channel, with hollowed out sections on the top and lower C sides. On the top side of the C-channel, a profile of the shape of the extruded rubber, used to lock clear plastic vinyl inside of it, is hallowed out. On the bottom side of the C-channel is a depression of a 1/16 inch, ¾″ wide, is made for soft weather stripping, that is pressed up against the rough opening/wall to create an airtight seal during testing.

### Method for Adjustable Chamber Construction and Usage

### Parts

#1—(2 pieces) Top left perimeter corner and bottom right perimeter corner (solid/male)

#2—(2 pieces) Top right perimeter corner and bottom left perimeter (solid/male)

#3—(2 pieces) Center flat sleeve (hollow/female)

#4—(1 piece) Center flat (solid/male)

#5—Perimeter profile sleeve (hollow/female)

#6—(4 pieces) Upper and lower jamb perimeter (solid/male)

#7—Right middle jamb crossmember (solid/male)—Has hole for manometer hose (machine to measure pressure)

#8—Left middle jamb crossmember—Has hole for vacuum hose

#9—Top head and lower sill center perimeter (solid/male)

#10—Extruded Rubber for attachment of clear vinyl

#11—Soft adhering weather stripping for compressing against the rough opening/drywall

#12—Clear Vinyl

### Steps

#1—Measure size of rough opening (width×length) that the chamber will be attached to. Using a square, mark on the floor with pencil the corners in the shape of an L. This outlines the edges of the chamber with the exact size of the rough opening.

#2—On all 4 corner perimeter pieces (part 1 and 2/males), slide a female hallow sleeve (part 5) onto each leg.

#2—Place the outer edges of all 4 perimeter corners (both pieces of parts #1 and #2) on pencil marks on the floor to create the exact dimensions of the rough openings. Ensure the groove for extruded rubber (part #11) for fastening of the clear vinyl is facing up.

#3—Place upper and lower center perimeter pieces (part 9) at the midpoint (width) of the sill and head of the chamber. Then slide the female sleeves from the corners onto the center pieces. Depending on size of chamber, ensure the sleeves allow for an approximate equal amount of overlapping onto each of the male profiles. This forms a solid form at the top and bottom of the chamber.

#4—At the upper and lower jambs of the chamber, insert a solid perimeter piece (part 6) into the female sleeve that is already connected to the leg facing down on each side.

#5—On both left and right middle jamb crossmembers (parts 7 and 8/males), slide a female hollow sleeve onto each end of both male profiles, placing the left and the right male profile at the midpoint (length) of the chamber.

#6—Using the female sleeves attached to the middle jamb crossmembers, slide female sleeves onto the upper and lower perimeter male pieces (part 6). This completes the perimeter assembly of the chamber.

#7—With the chamber still lying flat on the floor, orient clear vinyl (16 gauge) (part 12) over the chamber with the factory cut edges at the lower left corner, aligning edges of the vinyl with the track for the extruded rubber.

#8—Beginning at the lower left corner moving upward, insert extruded rubber into the track, compressing the clear vinyl into the track. Continue around the perimeter of the chamber, trimming the clear vinyl (as needed) to ensure the track is not filled with excess vinyl.

#9—With the rubber inserted into the track, the frame should be rigid. Pick up the chamber and flip it over, or stand it up on its side. Adhere weather stripping into groove around the perimeter of chamber. This will be the side that will be in contact with the rough opening/wall.

#10—Using telescoping rod, extend to the width of the chamber (interior), and place it inside the chamber, resting it on the midpoint. This prevents the chamber from flexing inward when pressure is applied.

#11—Using a telescoping rod and coder pin, attach bottom of chamber to the telescoping rod. Use the rod to set the chamber at the desired height of the chamber and place it over the window assembly (weather stripping down compressing to the rough opeing/wall) and place piece of blue painters tape from the chamber to the rough opening/wall to assist in keeping chamber in place for times during zero pressure during the test.

#12—Insert vacuum hose into hole of the left midpoint jamb and insert manometer hose into hole of right midpoint jamb.

#13—Turn on both vacuum and manometer and begin testing. Clear vinyl should be tightening and pulling towards the window assembly without leaving the groove behind the rubber.

1. A water penetration testing chamber comprises male extrusions and female extrusions wherein the male extrusions have exterior surfaces that slide into the space defined by the female extrusions' interior surfaces and the female extrusions each have an interior surface against which male extrusions' exterior surfaces can slide creating a telescoping assembly, altering the length and width of the chamber to fit the exact size of a rough opening of a window or door assembly.
